(19) United States
(12) Patent Application Publication
(10) Pub. No.: US 2015/0123594 A1
(43) Pub. Date: May 7, 2015

(54) Charging Device with Auto-On Circuit and System

(71) Applicant: Google Technology Holdings LLC, Mountain View, CA (US)

(72) Inventors: Daniel Nowak, Chicago, IL (US); Roshan Kamath, Hainesville, IL (US); Daniel H. Wagner, Grayslake, IL (US)

(21) Appl. No.: 14/098,898

(22) Filed: Dec. 6, 2013

Related U.S. Application Data
(60) Provisional application No. 61/899,785, filed on Nov. 4, 2013.

(51) Int. Cl. H02J 7/00

(52) U.S. Cl. CPC H02J 7/0052; H02J 7/0045; H02J 7/0021; H02J 7/007
USPC 320/107; 320/137

(57) ABSTRACT

An electronic device having an auto-on circuit is provided. The electronic device can include a power supply or charging circuit and a control circuit. The control circuit can cause the power supply or charging circuit to deliver energy to an external device. The auto-on circuit can activate the control circuit in response to one or more trigger input circuits. Each trigger input circuit can actuate a switch and deliver an auto-on signal to the control circuit. The control circuit can then actuate a latch to deliver power to a power input terminal to keep itself powered ON.

### CROSS-REFERENCE TO RELATED APPLICATION(S)

The present application claims priority to U.S. Provisional Patent Application No. 61/899,785, filed Nov. 4, 2013, which is hereby incorporated by reference herein in its entirety, and which is assigned to the same assignee as the present application.

### BACKGROUND

1. Technical Field

This disclosure relates generally to devices, and more particularly to electronic devices operable with other electronic devices.

2. Background Art

Portable electronic devices, such as mobile telephones, laptop computers, tablet computers, pagers, and two-way radios, for example, derive their portability from batteries. A typical battery disposed within one of these devices includes one or more electrochemical cells that may be charged and discharged to power the device. The use of rechargeable batteries allows mobile devices to slip the surly bonds of wall-tethered power connections to travel with users wherever they may go. When the battery becomes depleted, the user must couple the device to a charger to charge the battery. Once charged, the user can then detach the device from the charger to portably use the device until the battery is depleted.

Traditional chargers are generally powered from wall outlet via a power cord. Since these chargers have a relatively unlimited supply of power, they can be left ON all the time. Thus, to charge a device, the user simply attaches the device and walks away. However, some manufacturers have begun to develop portable chargers that a user can carry to charge devices that unexpectedly deplete their batteries. As these portable chargers rely on portable sources of energy, they frequently include a power button with which the user can turn the device ON for charging purposes. One frustrating experience that can occur with some chargers is forgetting to turn them ON after connecting the electronic device to be charged. A user who forgets to turn the charger ON may walk away for some period of time and then return, expecting a fully charged device, only to find that their device has not charged at all. It would be advantageous to have a device, system, or method capable of remedying such situations.

### BRIEF DESCRIPTION OF THE DRAWINGS

FIG. 1 illustrates one explanatory device configured in accordance with one or more embodiments of the disclosure.

FIG. 2 illustrates an alternate device configured in accordance with one or more embodiments of the disclosure working with another device.

FIG. 3 illustrates one explanatory device, and schematic block diagram, each configured in accordance with one or more embodiments of the disclosure.

FIG. 4 illustrates one explanatory schematic block diagram for a device configured in accordance with one or more embodiments of the disclosure.

FIG. 5 illustrates one explanatory schematic block diagram for a device configured in accordance with one or more embodiments of the disclosure.

FIG. 6 illustrates one explanatory method in accordance with one or more embodiments of the disclosure.

FIG. 7 illustrates various embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to providing an auto-on circuit and/or automatically actuating a control circuit of a device when another device is attached thereto. Any process descriptions or blocks in flow charts should be understood as representing modules, segments, or portions of code which include one or more executable instructions for implementing specific logical functions or steps in the process. Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

It will be appreciated that embodiments of the disclosure described herein may be comprised of one or more conventional processors and unique stored program instructions that control the one or more processors to implement, in conjunction with certain non-processor circuits, some, most, or all of the functions of automatically turning ON a control circuit of a first device when another device is attached as described herein. The non-processor circuits may include, but are not limited to, a radio receiver, a radio transmitter, signal drivers, clock circuits, power source circuits, and user input devices. As such, these functions may be interpreted as steps of a method to perform automatically actuating a control circuit in a first device when another device is attached. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Embodiments of the disclosure provide a circuit, system, device, and method that enables a control circuit, and thus an electronic device, to automatically turn ON when another device is attached to a connector. Accordingly, when a user connects a device configured in accordance with one or more embodiments of the disclosure to another device, the first device automatically turns ON without the necessity of pressing a button or other control device to turn it ON. Embodiments of the disclosure are particularly well suited to portable charging devices because the portable charging device can be left OFF to save power when not in use. However, when a user connects the portable charging device to another device, embodiments of the disclosure provide mechanisms, circuits, and methods to automatically turn the portable charging device ON without the user needing to press a button. Thus, charging is simply initiated by connecting the devices together. While a portable charging device will be used to illustrate operation of one or more embodiments of the disclosure, those of ordinary skill in the art having the benefit of this disclosure will recognize that the auto-on circuits and methods described herein will work with other devices as well.

In one embodiment, an electronic device includes one or more connectors to connect to one or more external devices. Charging circuitry is operable with one or more energy storage devices, such as a rechargeable battery, fuel cell, or supercapacitor, to deliver energy to the external device(s) through the connector(s). Accordingly, the charging circuitry and energy storage device(s) can be used to provide power to the external device(s), for normal on-state use and/or the charging of their own rechargeable battery or batteries, in one application.

In one embodiment, a control circuit is operable with the charging circuitry to actuate the charging circuitry when an external device is connected to at least one connector. An auto-on circuit is operable to actuate the control circuit when an external device is connected. In one embodiment, the auto-on circuit includes a switch, one or more trigger inputs for the switch, and a logical latch element. Where multiple trigger inputs are used to control the switch, they can be arranged in a logical OR configuration in one or more embodiments.

In one embodiment, when a trigger input actuates the solid-state switch, an auto-on signal is delivered to a terminal of the control circuit. The auto-on signal alerts the control circuit that it should actuate. In addition, the auto-on circuit allows power to pass through the switch to a power input terminal of the control circuit temporarily power the control circuit. The control circuit uses power delivered from the switch to actuate an output. The output actuates a latch to continue to deliver power to the power input terminal of the control circuit. In effect, a trigger input delivers a “wake up call” to the control circuit while it also causes the switch to deliver power to a power terminal of the control circuit. The control circuit can use energy from the switch to actuate the latch to continue to deliver power to the control circuit.

In one embodiment, a portable charging device utilizes a signal due to discharge of a biased booster output capacitance as a trigger input that occurs when an external device is connected. The external device, which may have a capacitive or resistive path to ground, i.e., a common node, loads the output capacitance. This external loading caused by the connection between devices generates a falling edge signal, which is used as a trigger input to actuate the switch, which in one embodiment is a transistor. The trigger input causes an auto-on signal to reach the control circuit in addition to causing the switch to deliver power to the control circuit, thus turning ON the control circuit and device. The control circuit then actuates a latch to continue to deliver power to its power input terminal.

In a charging application, embodiments of the disclosure enable automatic “turn ON” of a charger when an external device is connected. This is in contrast to a user having to press a button to turn the device ON. Advantageously, a user does not have to remember this activation step. While some prior art auto-on circuits have been proposed, they are generally far more complex and expensive than are embodiments of the present disclosure. Moreover, most prior art solutions require an additional terminal at the device/external device interface to detect when the external device is connected. Embodiments of the disclosure advantageously save tens of cents compared to prior art solutions in addition to reducing the number of interface connections.

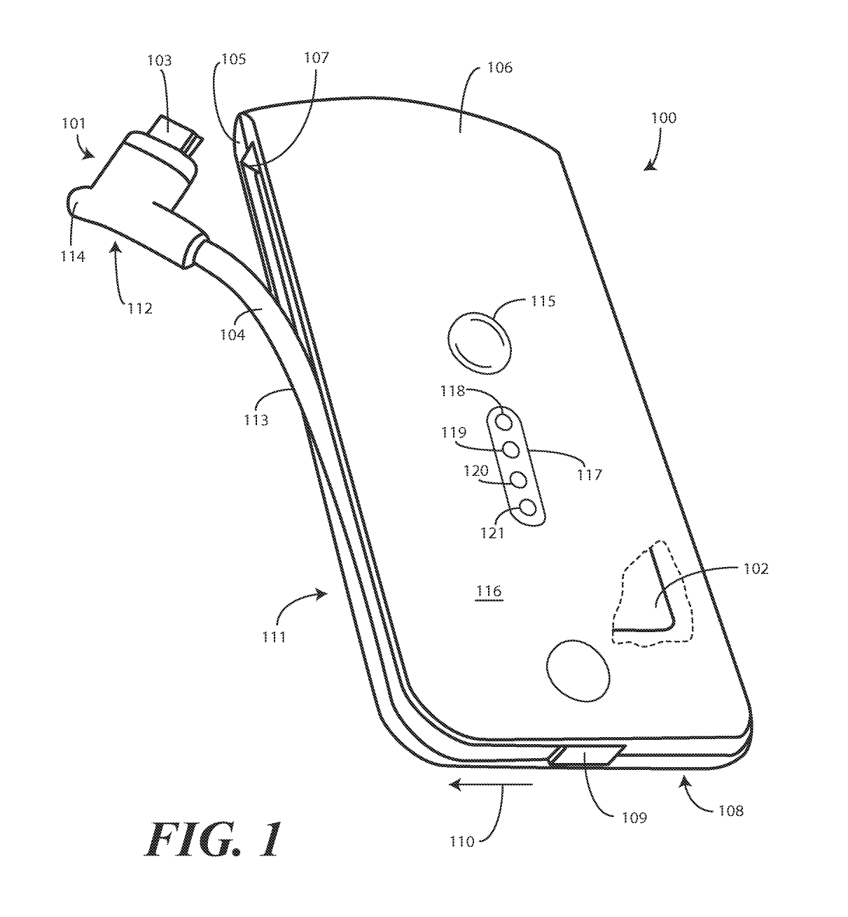

Turning now to FIG. 1, illustrated therein is one explanatory electronic device 100 configured in accordance with one or more embodiments of the disclosure. The explanatory electronic device 100 of FIG. 1 is shown as a portable charging device for illustrative purposes. However, it will be obvious to those of ordinary skill in the art having the benefit of this disclosure that other electronic devices may be substituted for the explanatory charging device of FIG. 1. For example, the electronic device 100 may be configured as a palm-top computer, a tablet computer, a gaming device, wearable computer, a media player, or other device, as any of these devices may have an application where an auto-on capability is required when the device is connected to another device. For example, two gaming devices may turn on when connected so that users could compete against each other in an electronic gaming environment.

The electronic device 100 of FIG. 1 includes an energy-sharing feature. In one or more embodiments, activation of the energy-sharing feature allows the user of the electronic device 100 to share energy stored within one or more energy storage device(s) disposed within the electronic device with one or more other device(s) via one or more power interface(s) 101, one example of which can include a connector. In one or more embodiments, the electronic device 100 includes a power interface 101 that is operable with the energy storage device 102. In this illustrative embodiment, the power interface 101 comprises a micro-USB connector 103 attached to the electronic device 100 by a flexible cable 104. In one embodiment, the power interface 101 can be used to deliver energy from the energy storage device 102 as well. For example, in one embodiment, the user can connect an external device to the power interface 101 so that energy from the energy storage device 102 can be delivered to the external device. This provides a convenient way for the user to share energy with a friend, for example, who may have a device with a depleted battery.

Illustrating by example, the one or more power interface(s) can comprise a micro-USB cable output and a fixed USB-A output. Similarly, the one or more energy storage device(s) can comprise one rechargeable battery, two rechargeable batteries, or more energy storage devices. Said generally, the electronic device 100 can incorporate one or more internal energy storage devices and can comprise one or more power interfaces for use by external devices. While USB interfaces are one type of power interface, others will be obvious to those of ordinary skill in the art having the benefit of this disclosure.

As shown in FIG. 1, in one or more embodiments the flexible cable 104 and the power interface 101 are stowable within the housing members 105,106 of the electronic device 100 when not in use. Accordingly, in one or more embodiments the user may stow the flexible cable 104 and the power interface 101 into a power interface receiver 107. In the illustrative embodiment of FIG. 1, the flexible cable 104 emanates from the bottom 108 of the electronic device 100. The power interface receiver 107 extends from the connection point 109 along one side 110 of the bottom 108 of the electronic device 100 and up one side 111 of the electronic device 100. When the power interface 101 is inserted into the power interface receiver 107, the exterior 112 of the micro-USB connector 103 and the exterior 113 of the flexible cable 104 define an exterior sidewall of the electronic device 100 that the user can hold. When the user desires to share energy with another device, they may lift a thumb tab 114 of the micro-USB connector 103 to curl the power interface and flexible cable 104 out of the power interface receiver 107. In one or more embodiments, a length of the flexible cable 104 is greater than a length of the side 111 of the electronic device 100 to give the user more flexibility in energy-sharing, as the external device attached to the power interface 101 need not be close to the electronic device 100

In one or more embodiments, the electronic device 100 is configured with only a single control button 115. In one embodiment, control button 115 defines a user interface capable of physical user actuation by touching or pressing, and is the only such user interface of the electronic device 100 in one embodiment. Other configurations will be obvious to those of ordinary skill in the art having the benefit of this disclosure.

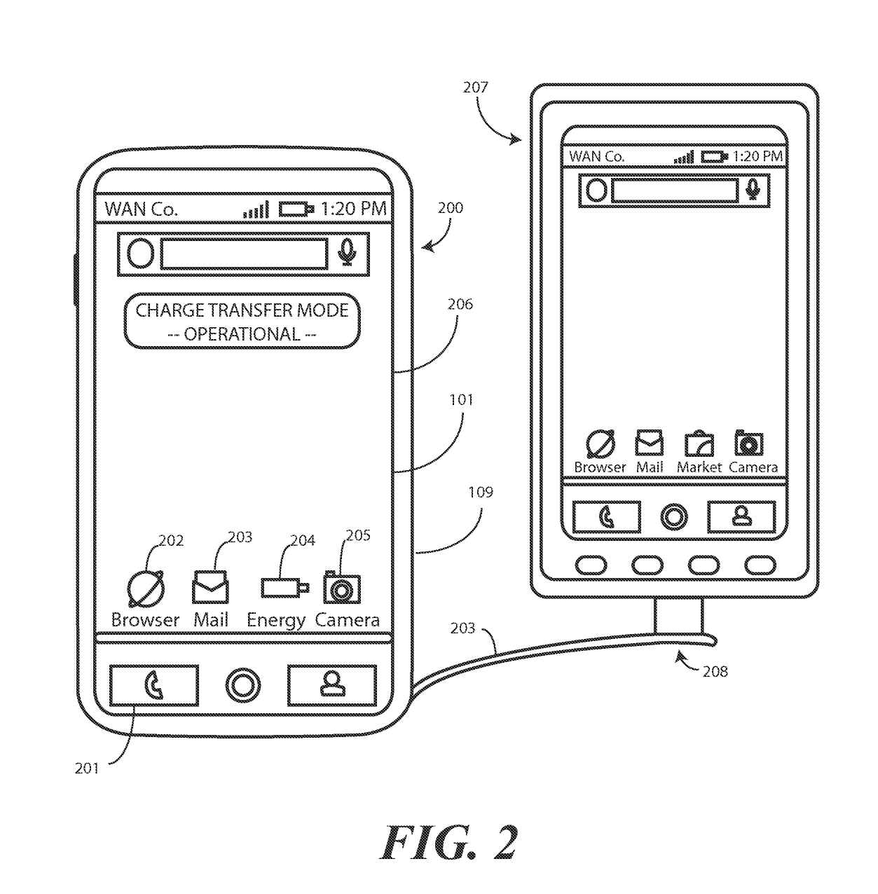

Note that the second major face 116 of the explanatory embodiment of FIG. 1 is generally convex in that a central portion of the second major face 116 of the electronic device 100 extends outwardly from the electronic device 100, i.e., up, to the right, and out of the page as viewed in FIG. 2, relative to the side portions of the second major face 116. While this is one configuration of the second major face 116 that is aesthetically pleasing and convenient for use by the user, it should be noted that housings of electronic devices employing embodiments of the disclosure can take a variety of shapes, and can be substantially planar, convex, concave, undulating, or combinations thereof.

In one or more embodiments, the electronic device 100 also includes an energy capacity indicator 117 that is operable with the energy storage device(s) 102. In this illustrative embodiment, the energy capacity indicator 117 comprises a plurality of lights 118,119,120,121, each of which is configured as a light emitting diode. In one embodiment the energy capacity indicator 117 is to present a visible indication to the user that is indicative of the amount of energy stored in the energy storage device 102. The energy capacity indicator 117 may be configured to convey other information as well, such as indicating that energy sharing is occurring through the power interface 101.

Turning now to FIG. 2, illustrated therein is another electronic device 200 having energy sharing capabilities in accordance with one or more embodiments of the disclosure. To show that energy sharing functions can be added to devices other than dedicated charging devices, the explanatory electronic device 200 of FIG. 2 is shown as a smart phone for illustrative purposes.

The electronic device 200 is capable of executing an operating system to generate an operating system environment. The operating system environment, which is configured as executable code operating on one or more processors or control circuits of the electronic device 200 in one embodiment, has associated therewith various applications or “apps.” Examples of such applications shown in FIG. 2 include a cellular telephone application 201 for making voice telephone calls, a web browsing application 202 configured to allow the user to view webpages on the touch-sensitive display 206 of the electronic device 200, an electronic mail application 203 configured to send and receive electronic mail, and a camera application 205 configured to capture still (and optionally video) images. These applications are illustrative only, as others will be obvious to one of ordinary skill in the art having the benefit of this disclosure.

The electronic device 200 also includes an energy-sharing application 204. In one or more embodiments, activation of the energy-sharing application 204 allows the user to share energy stored within an internal energy storage device with an external device 207 via the power interface 208. In one embodiment, the user can enter instructions and other control data into the energy-sharing application 204 to control how, if, and/or when energy is shared with other devices. For example in one embodiment, the user can enter user instructions into the energy-sharing feature to limit the amount of energy that can be shared with another device to permit the energy-sharing feature from consuming all of the energy stored in the energy storage device, which in this embodiment is a rechargeable electrochemical battery. In another embodiment, the user can enter user instructions to control the energy-sharing feature to define how much energy is to be shared with another device.

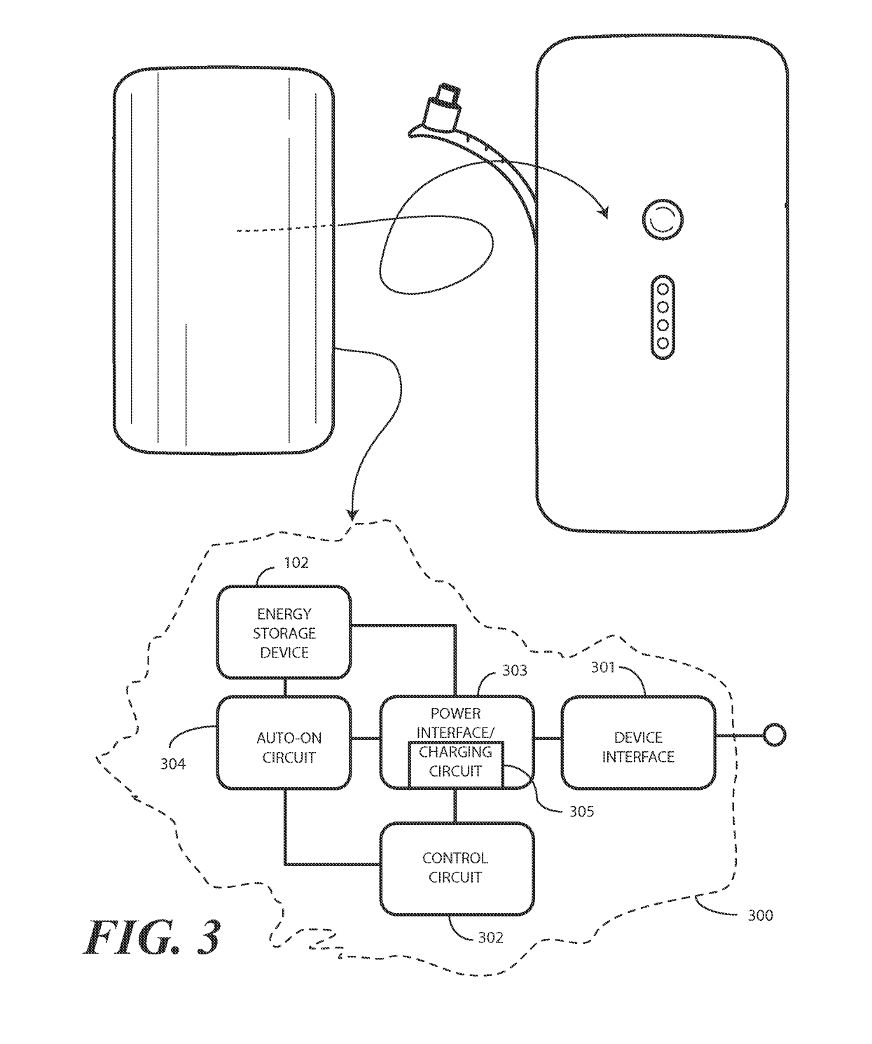

Turning now to FIG. 3, illustrated therein is the electronic device 100 of FIG. 1 with a block diagram schematic 300. As shown in FIG. 3, the electronic device 100 includes a device interface 301, which is in one embodiment a connector. The electronic device 100 also includes a control circuit 302, a power interface 303, power supply or charging circuit 305, and auto-on circuit 304, and an energy storage device 102.

The control circuit 302 can be responsible for performing the various functions of the electronic device 100, and can include one or more processors. For example, in one embodiment, the control circuit 302 is operable with the auto-on circuit 304 to power up the electronic device 100 when an external device is connected to the device interface 301. The control circuit 302 can be a microprocessor, a group of processing components, one or more Application Specific Integrated Circuits (ASICs), programmable logic, or other type of processing device. The control circuit 302 can be operable with other components of the electronic device 100, including the power interface 303 and power supply or charging circuit 305.

The control circuit 302 can be configured to process and execute executable software code to perform the various functions of the electronic device 100. A storage device, such as an on-board memory, stores the executable software code used by the control circuit 302 for device operation. The executable software code used by the control circuit 302 can be configured as one or more modules that are operable with the control circuit 302. Such modules can store instructions, control algorithms, and so forth. The instructions can instruct processors or control circuit 302 to perform the various steps for sharing energy from the energy storage device 102 as described herein. Alternatively, in other embodiments, such as that illustrated in FIG. 1, the control circuit may comprise analog or digital circuitry, unable to execute programs, but constructed in a manner sufficient to implement the desired control functions of the overall device.

In one embodiment, the energy storage device 102 is a rechargeable battery. For example, in one embodiment the energy storage device 102 can be a lithium-ion rechargeable battery. Lithium-ion cells are popular choices for use in batteries of many portable electronic devices. However, it will be clear to those of ordinary skill in the art having the benefit of this disclosure that other cell types could also be used with the energy storage device 102. For example, rather than using a lithium-ion cell, a lithium-polymer cell could be used. In other embodiments, the energy storage device 102 can be two, three, or more rechargeable batteries, which can be connected in series, parallel, or series-parallel configurations.

In one embodiment, the energy storage device 102 comprises at least one cell having an anode, a cathode, and one or more separator layers. The anode serves as the negative electrode, while the cathode serves as the positive electrode. The separator layers prevent these two electrodes from physically contacting each other. While the separator layers physically separate the cathode from the anode, the separator layers permit ions to pass from the cathode to the anode and vice versa so the energy storage device 102 can be charged or discharged.

In one embodiment, the anode and cathode each comprise a foil layer coated with an electrochemically active material. For example, the anode can include a copper foil layer that is coated with graphite in one embodiment. The cathode can include an aluminum foil layer that is coated with Lithium Cobalt Dioxide (LiCoO.sup.2). The separator layers electrically isolate the anode from the cathode, and comprise a polymer membrane in one or more embodiments.

The electrode assembly of the energy storage device 102 can be placed in an electrolyte. In one embodiment, the electrolyte is an organic electrolyte and provides an ionic conducting medium for lithium ions to move between the anode and cathode during charge and discharge of the energy storage device 102. The anode, cathode, and separator layers can be either wound in a jellyroll configuration or cut and stacked.

In one embodiment the power interface and power supply or charging circuit 305 is operable with the energy storage device 102. In one or more embodiments, the power supply or charging circuit 305 can be used to share energy stored within the energy storage device 102 with one or more other electronic devices. Optionally, the power interface 303 and power supply or charging circuit 305 can be used to charge the energy storage device 102 as well. However, some embodiments, the power interface 303 and power supply or charging circuit 305 will only be used to share energy with another device, and a separate charging connector (not shown) will be included for charging internal energy storage elements.

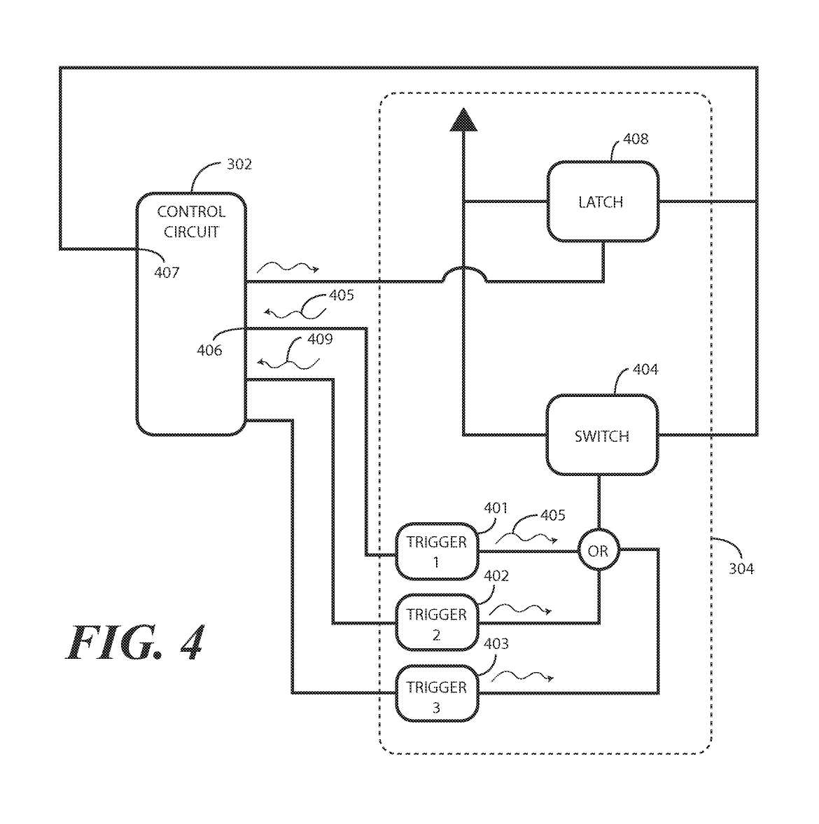

In one embodiment, the control circuit 302 is to actuate the power supply or charging circuit 305 so that the power supply or charging circuit 305 can deliver energy to an external device through the device interface 301, which in one embodiment is a connector. In one embodiment, the auto-on circuit 304 is configured to determine that another device is coupled to the device interface 301. When this occurs, the auto-on circuit 304 is to deliver an auto-on signal to the control circuit 302. The control circuit 302 is then, in response to receiving the auto-on signal, to actuate a latch to deliver power to a power input terminal of the control circuit 302 to keep the control circuit 302 powered. The control circuit 302 can then cause the power interface and power supply or charging circuit 305 to deliver energy through the device interface 301. This will be described in more detail with reference to FIGS. 4-6 below.

Beginning with FIG. 4, the control circuit 302 and auto-on circuit 304 are shown in a schematic block diagram. As mentioned above, in one embodiment the control circuit 302 is to cause the charging circuit (305) to deliver energy to an external device through a device interface (301) such as the power interface (101) shown in FIG. 1. In one embodiment, the auto-on circuit 304 is to activate the control circuit 302 when the external device is connected.

In this embodiment, the auto-on circuit includes a plurality of trigger input circuits 401,402,403. While three are shown for illustrative purposes, in some embodiments only one trigger input circuit will be present. In other embodiments, two, four, or more trigger input circuits will be present. These input circuits are referred to as “trigger input” circuits because they are used both actuate a switch 404 when their state changes and to deliver a control signal to the control circuit 302. Actuating the switch 404 causes power to be delivered to a power input terminal 407 of the control circuit 302 to momentarily turn the control circuit 302 ON. Delivering a control signal to the control circuit 302 indicates that the control circuit 302 should actuate a latch 408 to continue to remain powered ON. The trigger input circuits 401,402,403 thus provide both a signaling and powering function for the control circuit 302. Note that each function may be very short in some situations. Since the powering function may be short, the control circuit 302 actuates the latch 408 to remain operational in one or more embodiments. Note that in one or more embodiments, the switch and latch can be combined and a single, solid-state device can be used for both elements. For example, inputs to the switch 404 and latch 408 can be coupled to a single, solid-state device in an OR configuration in some applications. Additionally, the trigger can be static instead of transient to achieve a similar effect in other applications.

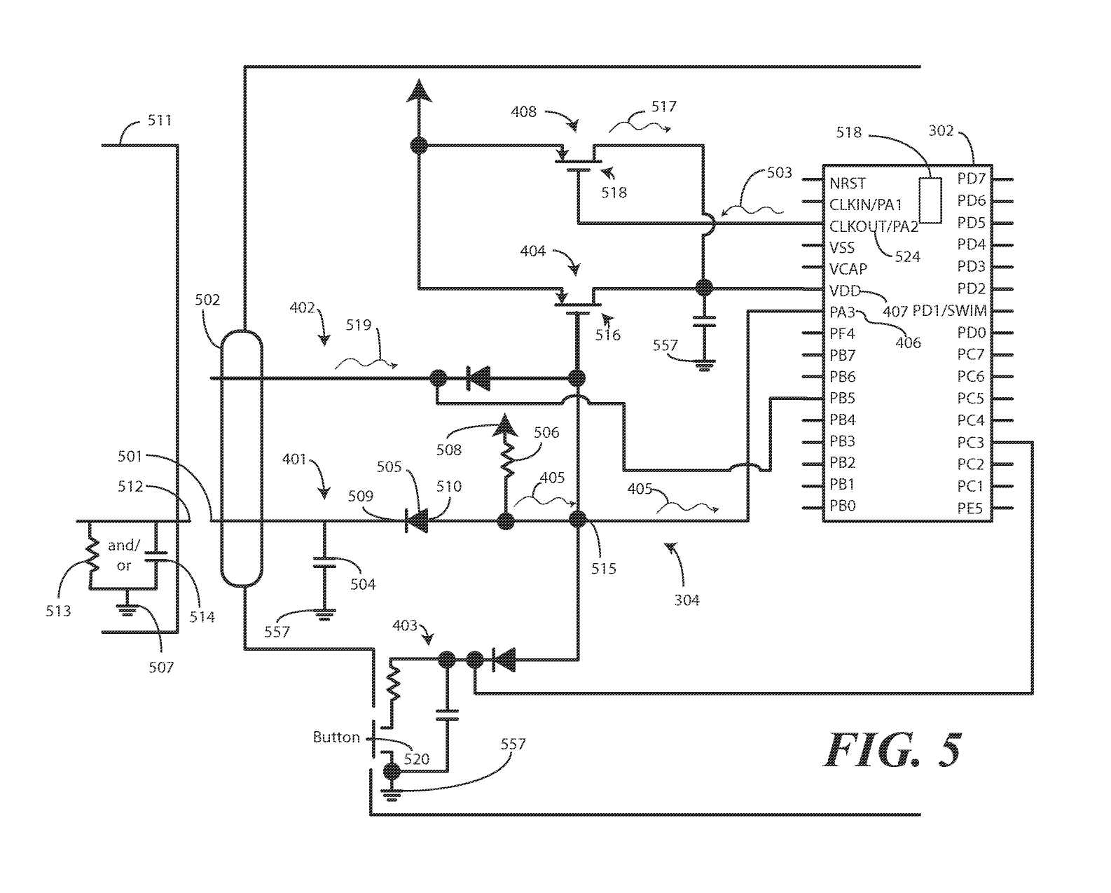

To be effective, the trigger input circuits 401,402,403 only have to be in a state active to control the switch 404 and deliver the auto-on signal 405 for a predefined duration that is sufficiently long for the control circuit 302 to actuate the latch 408. Once the latch 408 is latched, there is no need for the trigger input circuits 401,402,403 to remain active. As will be shown below with reference to FIG. 5, in one embodiment the state of a trigger input circuit is changed due to the discharge of a capacitor tied to the output pin of a connector. So long as this change in state occurs for a period sufficient for the control circuit 302 to latch the latch 408, the auto-on circuit 304 is effective.

In the illustrative embodiment of FIG.4, the trigger input circuits 401,402,403 are arranged in an “OR-ed” configuration. Accordingly, when any one of the trigger input circuits 401,402,403 changes state, the auto-on signal, e.g., auto-on signal 405, will be delivered to a signal input terminal 406 of the control circuit 302. Additionally, the switch 404 will be actuated. If two trigger input circuits, e.g., trigger input circuit 401 and trigger input circuit 402, change state simultaneously, two auto-on signals 405,409 will be delivered to the control circuit 302 and the switch 404 will be actuated as well.

When the switch 404 is actuated by one or more of the trigger input circuits 401,402 403, power is delivered to a power input terminal 407 of the control circuit 302. The control circuit 302, in response to receiving the auto-on signal 405 at the signal input terminal 406 and power at the power input terminal 407, then latches power to its power input terminal 407 by actuating the latch 408 to continue to power itself and remain operational. Once powered ON in a continuous operational mode, the control circuit 302 can cause the charging circuit (305) to deliver power to one or more external devices.

Turning now to FIG. 5, illustrated therein is a more detailed schematic diagram of one explanatory control circuit 302 and auto-on circuit 304 configured in accordance with one or more embodiments of the disclosure. In this illustrative embodiment, the control circuit 302 is an STM8S 8-bit microcontroller with on-board memory manufactured by STMicroelectronics. This is but one possible example for the control circuit, as others will be obvious to those of ordinary skill in the art having the benefit of this disclosure.

The auto-on circuit 304 of this illustrative embodiment includes three trigger input circuits 401,402,403. The auto-on circuit 304 also includes a switch 404 and a latch 408. In one embodiment, either or both of the switch 404 and the latch 408 are configured as transistors. In the illustrative embodiment of FIG. 5, both the switch 404 and the latch 408 are configured as Field Effect Transistors (FETs). Other devices, including relays, Bipolar Junction Transistors (BJTs), and the like could be used as the switch 404 and the latch 408 in other embodiments.

In this illustrative embodiment, the first trigger input circuit 401 is responsive to a resistive load and/or a capacitive discharge at a terminal 501 of a connector 502 to cause the switch 404 to deliver power to a power input terminal 407 of the control circuit 302. The first trigger input circuit 401 also causes an auto-on signal 405 to be delivered to a signal input terminal 406 of the control circuit 302. (Note that delivery of the auto-on signal 405 to the control circuit 302 is optional in some applications. It can be advantageous, however, in that it allows the control circuit 302 to run diagnostic checks to determine its operating conditions in response to receipt of the auto-on signal 405 at its signal input terminal 406.) When this occurs, i.e., after receiving the auto-on signal 405, the control circuit 302 generates a control signal 503 at an output terminal 524 to actuate the latch 408 so that power continues to be delivered to its power input terminal 407 as previously described.

In one embodiment, the first trigger input circuit 401 comprises a passive circuit. The term “passive” is used to refer to a circuit that includes exclusively components that do not supply energy and/or generate their own active signals. Illustrating by example, resistors, capacitors, and inductors are all passive components because they do not supply energy. By contrast, a battery, transistor, or op-amp would be an active component because it supplies energy to a circuit. In this illustrative embodiment, the first trigger input circuit 401 is passive in that it includes only a capacitor 504, diode 505, and resistor 506.

In one embodiment, the capacitor 504 is coupled between an output terminal 501 of the connector 502 and a common node 507, which is a ground reference in FIG. 5. The diode 505 is coupled to the capacitor 504, and the resistor 506 is coupled between a node 508 coupled to an energy storage device (102) of the electronic device. Node 508 in this illustrative embodiment is a power supply rail driven by a rechargeable battery. In one embodiment, the cathode 509 of the diode 505 is coupled to the capacitor 504, and the anode 510 of the diode is coupled to the resistor 506, the switch 404, and a signal input terminal 406 of the control circuit 302. Note that in one or more embodiments the capacitor 504 is optional, but is sometimes included for electrostatic discharge or other transient protection in addition to any signaling that may be provided when required by a particular application.

When an external device 511 is attached to the connector 502, a terminal 512 of the external device 511 couples with a terminal 501 of the connector 502. In one or more embodiments, the terminal 512 of the external device 511 has a direct or indirect path to the common node 507. For example, the path can be a direct path through a resistor 513. Alternatively, the path can be a leakage path through a capacitor 514, inductor, or other component. Note that in one or more embodiments, the common node 507 is coupled to a common node 557 of the electronic device when connector 502 connects to the external device 511.

When the terminal 512 of the external device 511 couples with the terminal 501 coupled to the capacitor 504, loading at the DC-biased output terminal 501 occurs. This loading causes the voltage present at terminal 501 to fall, which may be due to at least a partial discharge of the optional capacitor 504, which is ordinarily biased to the supply rail through the resistor 506. The drop in voltage at terminal 501 causes a node 515 at the anode 510 of the diode 505 to drop, i.e., go active low. This causes the control terminal 516 of the switch 404, e.g., the gate of a MOSFET in this embodiment, to turn the switch 404 ON, thereby delivering power from the supply rail to the power input terminal 407 of the control circuit 302. This is how trigger input circuit 401 is responsive to a resistive loading and/or capacitive discharge at the terminal 501 of the connector 502 when the external device 511 is attached thereto in this embodiment.

When the control circuit 302 receives the auto-on signal 405, the control circuit 302 is to latch power 517 to the power input terminal 407. In one embodiment, it does this by delivering a control signal 503 to the latch 408. In the illustrative embodiment of FIG. 5, the latch 408 is configured as a transistor coupled between the supply rail and the power input terminal 407. When the control signal 503 is delivered to the control terminal of the latch, e.g., the gate of a MOSFET in this embodiment, the latch 408 activates to continue to power the control circuit 302.

In one embodiment, the control circuit 302 is to cease latching power 517 to the power input terminal 407 upon detecting the occurrence of a power down event 518. The power down event 518 can take any of a variety of forms. For example, if the device is a portable charging device, and the energy storage device is becoming depleted, the control circuit 302 may detect this power down event 518 and cease charging. Afterwards, to save power, the control circuit may cease the latching by discontinuing the control signal 503.

In this embodiment, the auto-on circuit 304 includes two other trigger input circuits 402,403. In one embodiment, the second trigger input circuit 402 is responsive to an input signal 519 received from an external device. For example, if the energy storage device of the device is to be recharged, an external charging device may deliver the input signal 519 indicating that the energy storage device is about to be charged. As with the resistive loading and/or capacitive discharge occurring with the first trigger input circuit 401, receipt of the input signal 519 causes an auto-on signal to be delivered to a signal input terminal of the control circuit 302. Additionally, the switch 404 will be actuated. The control circuit 302 can then latch the latch 408 as previously described to remain powered ON.

In one embodiment, the third trigger input circuit 403 is responsive to a user control actuator, which is shown as a push-button 520 in FIG. 5. When the push-button 520 is pressed, an auto-on signal will be delivered to a signal input terminal of the control circuit 302. Additionally, the switch 404 will be actuated. The control circuit 302 can then latch the latch 408 as previously described to remain powered ON.

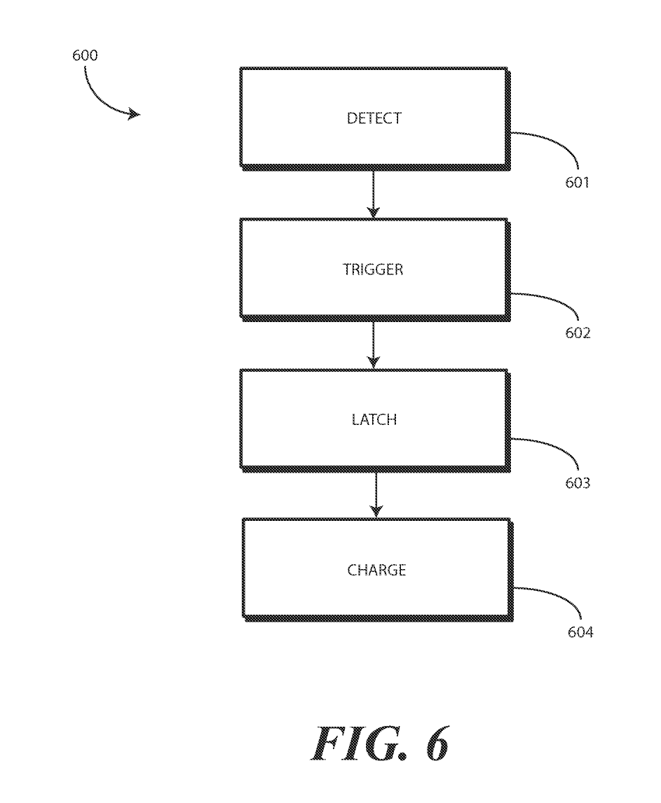

Turning to FIG. 6, illustrated therein is a flow chart depicting a method 600 for automatically turning on a control circuit in accordance with one or more of the circuits described above. At step 601, the method 600 detects a capacitive discharge at a terminal of a device. In one embodiment, step 601 occurs in response to an external device being coupled to a terminal.

At step 602, the method 600 triggers a switch in response to the detecting occurring at step 601. In one embodiment, the method also delivers an auto-on signal to the control circuit at step 602. In one embodiment, the method 600 triggers the switch alternatively in response to other inputs at step 602. For example, in one embodiment step 602 includes triggering the switch and delivering the auto-on signal in response to user actuation of a user control actuator. In another embodiment, step 602 includes triggering the switch and delivering the auto-on signal in response to an input signal indicating an energy storage device is to be charged.

At step 603, the method 600 latches power to the control circuit in response to the triggering occurring at step 602. In one embodiment, the latching occurring at step 603 occurs with an output of a control circuit. At step 604, the method 600 charges an energy storage device of an external device. In one embodiment, step 604 occurs in response to the latching occurring at step 603.

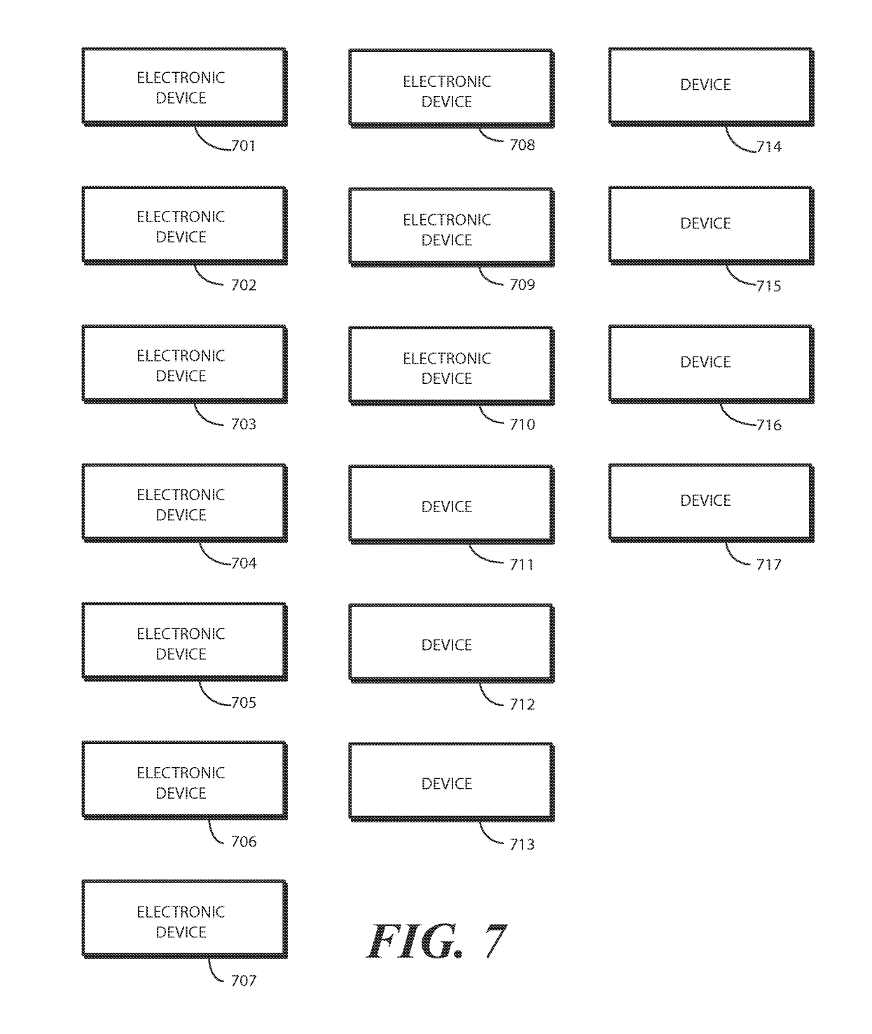

Turning now to FIG. 7, illustrated therein are various embodiments of the disclosure. At 701, an electronic device comprises a connector to connect to an external device(s). At 701, the electronic device can comprise a DC-DC boost converter circuit to deliver energy through the connector. At 701, the electronic device can comprise a control circuit to actuate the charging circuit. At 701, the electronic device can comprise an auto-on circuit to actuate the control circuit.

In one embodiment, the auto-on circuit of 701 comprises a switch. In one embodiment, the auto-on circuit of 701 comprises a trigger input circuit for the switch. In one embodiment, the auto-on circuit of 701 also comprises a latch. In one embodiment, the trigger input circuit of 701 is responsive to a resistive loading and/or a capacitive discharge at a terminal of the connector when the external device is coupled to the connector. In one embodiment, the trigger input circuit of 701 is to deliver an auto-on signal to the control circuit and the switch. In one embodiment, the control circuit of 701 is to actuate the latch to deliver power to a power input terminal of the control circuit after receiving the auto-on signal.

At 702, the switch of 701 comprises a transistor. At 703, the trigger input of 701 is a passive circuit. In one embodiment, at 703 the trigger input of 701 comprises a capacitor, a resistor, and a diode. In one embodiment, the capacitor of 701 is coupled between the terminal of 701 and a common node. In one embodiment, the diode of 703 is coupled to the capacitor of 703. In one embodiment, the resistor of 703 is coupled between the diode and a node coupled to an energy storage device of the electronic device.

At 704, a cathode of the diode of 703 is coupled to the capacitor of 703. At 704, the anode of the diode of 703 is coupled to the resistor of 703.

At 705, the latch of 701 comprises a transistor coupled between a node coupled to an energy source and the power input terminal At 705, the control circuit of 701 is to actuate the latch by delivering a control signal to a control terminal of the transistor. At 706, the control signal of 705 is active low.

At 707, the control circuit of 701 is to cease latching power to the power input terminal of the control circuit upon detecting occurrence a power down event. At 708, the auto-on circuit of 701 comprises a second trigger input circuit for the switch arranged in an OR configuration with the trigger input circuit. At 709, the second trigger input of 708 is from a user control actuator. At 710, the second trigger input of 708 is responsive to an input signal indicating an energy storage device of the electronic device is to be charged.

At 711, a device comprises a charging circuit, a control circuit, and an auto-on circuit. At 711, the control circuit is to cause the charging circuit to deliver energy to an external device. At 711, the auto-on circuit is to activate the control circuit. At 711, the auto-on circuit can comprise a plurality of trigger input circuits. At 711, the plurality of trigger input circuits can be arranged in an OR configuration. At 711, each trigger input circuit can be to actuate a switch and to deliver an auto-on signal to the control circuit. At 711, the control circuit can latch power to a power input terminal of the control circuit after receiving the auto-on signal.

AT 712, at least one trigger input circuit of 711 can be responsive to a capacitive discharge at a terminal of a connector of the device when the external device is attached thereto. At 713, the device of 711 can further comprise an energy storage device. At 713, at least one trigger input circuit of 711 can be responsive to an input signal indicating the energy storage device is to be charged.

At 714, the device of 711 can further comprise a user control actuator. At 714, at least one trigger input circuit of 711 can be responsive to user actuation of the user control actuator. At 715, the user control actuator of 714 can be a push button. At 716, a resistor and a diode can be disposed between the user control actuator and the switch of 711.

At 717, the auto-on circuit of 711 can comprise a capacitor coupled between an output terminal and a common node. At 717, the auto-on circuit of 711 can comprise a diode coupled to the capacitor. At 717, the auto-on circuit of 711 can comprise a resistor coupled between the diode and an energy storage device of the device.

As described above, in one embodiment a switch provides power to a control circuit when an external device is connected to a connector. In one embodiment, this connection causes a bias voltage at a terminal such as 501, which may be a voltage also across an output capacitance, to collapse, which generates a falling edge signal. The falling edge signal actuates a switch to provide power to the control circuit. The control circuit then actuates a latch to keep itself powered ON. Once the latch is actuated, the control circuit can cause a charging circuit to deliver energy to the external device.

In another embodiment, at 701, an electronic device comprises one or more connectors to connect to one or more external devices. At 701, a power supply circuit is to deliver energy through the one or more connectors. At 701, a control circuit is to actuate the power supply circuit. At 701, an auto-on circuit is to actuate the control circuit.

At 701, in one embodiment, the auto-on circuit comprises a switch, a trigger input circuit for the switch, and a latch. At 701, the trigger input circuit can be responsive to loading at a terminal of the one or more connectors when the one or more external devices is coupled to the one or more connectors to deliver an auto-on signal to the control circuit and the switch. At 701, the control circuit can actuate the latch to deliver power to a power input terminal of the control circuit after receiving the auto-on signal.

In one embodiment, at 702, the switch of 701 can comprise a transistor. At 702, in one embodiment the trigger input can comprise a passive circuit comprising a diode coupled to the terminal and a resistor coupled between the diode and a node coupled to a powered node of the electronic device.

At 704, in one embodiment the cathode of the diode of 703 can be coupled to the terminal, while an anode of the diode is coupled to the resistor and the switch. At 705, the latch of 701 can comprises a transistor coupled between a node coupled to an energy source and the power input terminal At 705, the control circuit of 701 can be to actuate the latch by delivering a control signal to a control terminal of the transistor.

At 706, the control signal of 705 can be active low. At 701, the control circuit of 701 can cease latching the power to the power input terminal upon detecting occurrence a power down event. At 708, the device of 701 can comprise a second trigger input circuit for the switch arranged in an OR configuration with the trigger input circuit. At 709, the second trigger input circuit of 708 can be responsive to a user control actuator. At 710, the second input trigger circuit of 708 can be responsive to an input signal indicating an energy storage device of the electronic device is to be charged.

At 711, in another embodiment, a device can comprise a charging circuit. At 711, a control circuit can cause the charging circuit to deliver energy to at least one external device. At 711, an auto-on circuit can activate the control circuit, the auto-on circuit comprising a plurality of trigger input circuits, arranged in an OR configuration, each trigger input circuit to actuate a switch and to deliver an auto-on signal to the control circuit. At 711, the control circuit can latch power to a power input terminal of the control circuit after receiving the auto-on signal.

At 712, at least one trigger input circuit of 711 can be responsive to a loading at a terminal of a connector of the device when the at least one external device is attached thereto. At 713, the device of 711 can comprise at least one energy storage device, and at least one trigger input circuit can be responsive to an input signal indicating the at least one energy storage device is to be charged.

At 714, the device of 711 can, in one embodiment, comprise a user control actuator. At 714, at least one trigger input circuit of 711 can be responsive to user actuation of the user control actuator. AT 715, the user control actuator of 714 can comprise a push button. At 716, the device of 711 can comprise a resistor and a diode disposed between the user control actuator and the switch. At 717, the auto on circuit of 711 can comprise a capacitor coupled between an output terminal and a common node, a diode coupled to the output terminal, and a resistor coupled between the diode and an energy storage device of the device.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. An electronic device, comprising:
one or more connectors to connect to one or more external devices;
a power supply circuit to deliver energy through the one or more connectors;
a control circuit to actuate the power supply circuit; and
an auto-on circuit to actuate the control circuit, the auto-on circuit comprising:
a switch;
a trigger input circuit for the switch; and
a latch;
the trigger input circuit responsive to loading at a terminal of the one or more connectors when the one or more external devices is coupled to the one or more connectors to deliver an auto-on signal to the control circuit and the switch;
the control circuit to actuate the latch to deliver power to a power input terminal of the control circuit after receiving the auto-on signal.

2. The electronic device of claim 1, the switch comprising a transistor.

3. The electronic device of claim 1, the trigger input circuit a passive circuit comprising:
a diode coupled to the terminal; and
a resistor coupled between the diode and a node coupled to a powered node of the electronic device.

4. The electronic device of claim 3, a cathode of the diode coupled to the terminal, an anode of the diode coupled to the resistor and the switch.

5. The electronic device of claim 1, the latch comprising a transistor coupled between a node coupled to an energy source and the power input terminal, the control circuit to actuate the latch by delivering a control signal to a control terminal of the transistor.

6. The electronic device of claim 5, the control signal being active low.

7. The electronic device of claim 1, the control circuit to cease latching the power to the power input terminal upon detecting occurrence of a power down event.

8. The electronic device of claim 1, further comprising a second trigger input circuit for the switch arranged in an OR configuration with the trigger input circuit.

9. The electronic device of claim 8, the second trigger input circuit responsive to a user control actuator.

10. The electronic device of claim 8, the second trigger input circuit responsive to an input signal indicating an energy storage device of the electronic device is to be charged.

11. A device, comprising:
a charging circuit;
a control circuit to cause the charging circuit to deliver energy to at least one external device; and
an auto-on circuit to activate the control circuit, the auto-on circuit comprising a plurality of trigger input circuits, arranged in an OR configuration, each trigger input circuit to actuate a switch and to deliver an auto-on signal to the control circuit;
the control circuit to latch power to a power input terminal of the control circuit after receiving the auto-on signal.

12. The device of claim 11, at least one trigger input circuit responsive to a loading at a terminal of a connector of the device when the at least one external device is attached thereto.

13. The device of claim 11, further comprising at least one energy storage device, at least one trigger input circuit responsive to an input signal indicating the at least one energy storage device is to be charged.

14. The device of claim 11, further comprising a user control actuator, at least one trigger input circuit responsive to user actuation of the user control actuator.

15. The device of claim 14, the user control actuator comprising a push button.

16. The device of claim 14, further comprising a resistor and a diode disposed between the user control actuator and the switch.

17. The device of claim 11, the auto-on circuit comprising:
a capacitor coupled between an output terminal and a common node;
a diode coupled to the output terminal; and
a resistor coupled between the diode and an energy storage device of the device.

18. A method, comprising:
detecting loading at a terminal of a device in response to an external device being coupled to the terminal;
triggering a switch in response to the detecting to deliver an auto-on signal to a control circuit; and
latching, with an output of the control circuit, power to the control circuit in response to the triggering.

19. The method of claim 18, further comprising alternatively triggering the switch in response to user actuation of a user control actuator.

20. The method of claim 18, further comprising delivering power to the external device in response to the latching.
